(19) United States
(12) Patent Application Publication
(10) Pub. No.: US 2016/0135202 A1
(43) Pub. Date: May 12, 2016

(54) Method and First Radio Node for Conveying a Message to a Second Radio Node

(71) Applicant: TELEFONAKTIEBOLAGET LM ERICSSON (PUBL), Stockholm (SE)

(72) Inventor: Niclas Nors, Mjölby (SE)

(21) Appl. No.: 14/901,133

(22) PCT Filed: Jun. 28, 2013
(86) PCT No.: PCT/SE2013/050816

§ 371 Date: Dec. 28, 2015

(51) Int. Cl. H04W 72/08; H04L 12/26; H04W 24/10; H04W 72/04; H04W 72/10

(52) U.S. Cl. CPC H04W 72/085; H04W 72/0406; H04W 72/10; H04W 24/10; H04L 43/087; H04L 43/0858; H04L 43/0894

(57) ABSTRACT

A method and first radio node (400) of a mobile network, for conveying a message (M) to a second radio node (402) of the mobile network. The first radio node (400) identifies transport requirements of the message and determines whether the transport requirements are fulfilled by link characteristics of a fixed interface to the second radio node or not. If not fulfilled, the message is sent over a radio interface to the second radio node. If the transport requirements are fulfilled by the link characteristics of a fixed interface, the message is instead sent over the fixed interface to the second radio node.

### TECHNICAL FIELD

The present disclosure relates generally to a method and a first radio node of a mobile network for wireless communication, for conveying a message to a second radio node of the mobile network.

### BACKGROUND

In recent years, different types of mobile networks for wireless communication have been developed to provide radio access for mobile terminals in different areas. The mobile networks are constantly improved to provide better coverage and capacity to meet the demands from users using various communication services and increasingly advanced terminals, e.g. smartphones and tablets, which may require considerable amounts of bandwidth and resources for data transport over a radio interface in the networks. As a result, it is common to configure a mobile network with cells of varying types and sizes, e.g. in an overlapping fashion, to provide needed capacity and flexibility depending on expected traffic intensity in different areas, the cells thus forming a so-called heterogeneous cellular network.

In this disclosure, the term “radio node” will be used to represent any node of a mobile network that can communicate radio signals with a mobile terminal, sometimes also called User Equipment, UE. A radio node as described in this disclosure could also be referred to as a base station, NodeB, e-NodeB, eNB, base transceiver station, etc., depending on the terminology used. Further, a mobile terminal in this disclosure could also be referred to as a UE, wireless device, mobile device, mobile station, or any other equivalent term.

A heterogeneous mobile network may thus comprise hierarchically arranged radio nodes, including macro nodes transmitting with relatively high power and covering relatively large areas of a size in the order of kilometers, and low power nodes transmitting with relatively low power and covering areas of a size in the order of a few meters, e.g. micro, pico, femto and relay nodes, to mention some customary examples. The low power nodes may be employed together with the macro nodes in an overlapping fashion to locally provide added capacity in so-called “hot spot” areas such that multiple small areas served by such micro/pico/femto/relay nodes may be located within the larger area served by a macro node. Further, the macro node and the low power nodes may cover their own individual cells, or may act as multiple transmission/reception points in a common or shared cell, also referred to as a cluster cell.

When a heterogeneous mobile network is deployed as described above, some areas will unavoidably be covered by more than one radio node such that interference may occur in the overlapping areas. Therefore, some coordination of radio transmissions in different cells or coverage areas will be necessary to avoid or at least reduce the amount of radio interference between transmissions in the different cells. In order to achieve such coordination of transmissions in the cells, various cell coordination messages are often exchanged over a communication interface between radio nodes serving cells potentially causing or suffering interference. Cell coordination messages may also be related to other things, apart from reducing interference, that may improve performance and/or capacity in the network, such as coordination of transmission of control information and reference signals, settings of various communication parameters, etc.

In FIG. 1, a heterogeneous mobile network is depicted where a macro node 100 covers a large macro cell 100a and two exemplifying pico nodes 102, 104 cover smaller pico cells 102a and 104a, respectively, which are located within the coverage area of the macro cell 100a. Different adjacent pico cells may also overlap one another. In this example, a communication interface called X2 is used for conveying messages between the radio nodes 100, 102 and 104. The X2 interface has been defined for the standard of Long Term Evolution, LTE, developed by the Third Generation Partnership Project, 3GPP. In addition to the above-mentioned cell coordination messages, the X2 interface can be used for conveying messages related to handover, load management, network optimization, radio node configuration, neighbor lists, and parameters used for handover and cell reselection, among other things. For example, the X2 interface may be used for signaling between a macro node and a low power node, or between two macro nodes, or between two low power nodes, as indicated in the figure.

Measurements made by radio nodes on uplink signals and/or measurements made by mobile terminals on downlink signals are often used for coordinating the radio communication in neighboring cells, such that measurement results obtained by one radio node are communicated to and used by another neighboring radio node to schedule transmissions therein, e.g. in a way that reduces interference in one or both of the cells covered by the radio nodes. This type of coordination of transmissions is commonly referred to as Inter-Cell Interference Coordination, ICIC, and/or Co-ordinated Multi-Point, CoMP. For example, an aggressor cell potentially causing interference may decide or agree to mute its transmissions during certain time intervals when interference-sensitive reference signals are transmitted in a neighboring victim cell potentially suffering interference. In the case of CoMP, various messages are communicated between radio nodes in order to improve performance and capacity in the network.

In order to enable efficient cell coordination or to ensure a successful handover, some of the above exemplifying messages between radio nodes must be conveyed very rapidly, e.g. before they become out-of-date or irrelevant. In particular, some mechanisms for cell coordination are dependent on rapid exchange of scheduling information and other information between the radio nodes so that reduced interference and/or improved performance can be achieved. However, it is a problem that some interfaces of today between radio nodes are too slow, in other words the latency of the interface is too great, such that the demands for rapid exchange of certain messages cannot always be met. Another potential problem is that some messages may require a certain bandwidth that the interface cannot fulfill. If the interface is comprised of a single uninterrupted cable extending directly between two radio nodes, or when using a link with only a few node hops, the messages can be conveyed with sufficiently low latency and acceptable bandwidth, particularly when fiber links are used. Such a fast connection may however not be available in practice depending on how the interface has been implemented, e.g. with consideration of costs, usage of already existing communication links, and so forth.

FIG. 2 illustrates that an X2 interface between two radio nodes 200 and 202 may run over a transport network 204, also referred to as a backhaul network, with a certain amount of various routers and switches. A cell site router 200a, 200b is also implemented at each radio node 200 and 202, respectively. In some cases, an X2 message conveyed over the X2 interface to a neighboring node must be routed over a substantial number of routers and switches in the transport network 204 and each routing or switching step, i.e. node hop, typically adds a delay of the message such that the total delay before the message arrives at the receiving radio node 202 becomes harmful to the performance of one or both of the radio nodes. It is thus a problem that the latency of a conventional interface between radio nodes may be so great that the performance in the mobile network is deteriorated, e.g. due to slow cell coordination or unsuccessful handovers. Another problem is that the latency of the interface may also change over time, e.g. due to varying load on routers, switches and links in the transport network 204, which makes it hard to predict or estimate the delay of the X2 signaling. Another problem is that the bandwidth of the interface may not be sufficient to convey messages with satisfactory bitrate.

### SUMMARY

It is an object of embodiments described herein to address at least some of the problems and issues outlined above. It is possible to achieve this object and others by using a method and a first radio node as defined in the attached independent claims.

According to one aspect, a method is performed by a first radio node of a mobile network for wireless communication, for conveying a message to a second radio node of the mobile network. In this method, the first radio node identifies transport requirements of the message and then sends the message over a radio interface to the second radio node in case the transport requirements of the message are not fulfilled by link characteristics of a fixed interface to the second radio node. Further, the first radio node sends the message over the fixed interface to the second radio node in case the transport requirements of the message are fulfilled by the link characteristics of the fixed interface.

According to another aspect, a first radio node of a mobile network for wireless communication is configured to convey a message to a second radio node of the mobile network. The first radio node comprises a fixed sending unit configured to send messages over the fixed interface to the second radio node, and a radio sending unit configured to send messages over a radio interface to the second radio node.

The first radio node also comprises a logic unit configured to identify transport requirements of the message. The logic unit is further configured to decide that the first message should be sent to the second radio node over the radio interface in case the transport requirements of the message are not fulfilled by link characteristics of a fixed interface to the second radio node, or over the fixed interface in case the transport requirements of the message are fulfilled by the link characteristics of the fixed interface.

An advantage that may be achieved when this solution is applied for conveying various messages to the second radio node, is that any urgent message that needs to be conveyed rapidly and/or with sufficient bitrate will be sent over the radio interface in case the fixed interface is not able to convey the message according to its transport requirements. Another advantage is that other not so urgent messages will not consume precious radio resources by being conveyed over the fixed interface instead in case the fixed interface is actually able to convey the message according to its transport requirements.

The above method and first radio node may be configured and implemented according to different optional embodiments to accomplish further features and benefits, to be described below.

### BRIEF DESCRIPTION OF DRAWINGS

The solution will now be described in more detail by means of some exemplifying embodiments and with reference to the accompanying drawings, in which:

FIG. 1 is a communication scenario illustrating a conventional LTE mobile network with fixed X2 interfaces between radio nodes, according to the prior art.

FIG. 2 illustrates how an X2 interface may run over a transport network of routers and switches, according to the prior art.

FIG. 3 is a flow chart illustrating a procedure performed by a first radio node when conveying a first message to a second radio node, according to some possible embodiments

FIG. 4 is a block diagram illustrating a first radio node in more detail, according to further possible embodiments.

FIG. 5 is a flow chart illustrating a more detailed example of how the first radio node may operate, according to further possible embodiments.

FIG. 6 is a communication scenario illustrating that the first radio node relays a message from a third radio node to the second radio node, according to further possible embodiments.

FIG. 7 is another block diagram illustrating a first radio node, according to further possible embodiments.

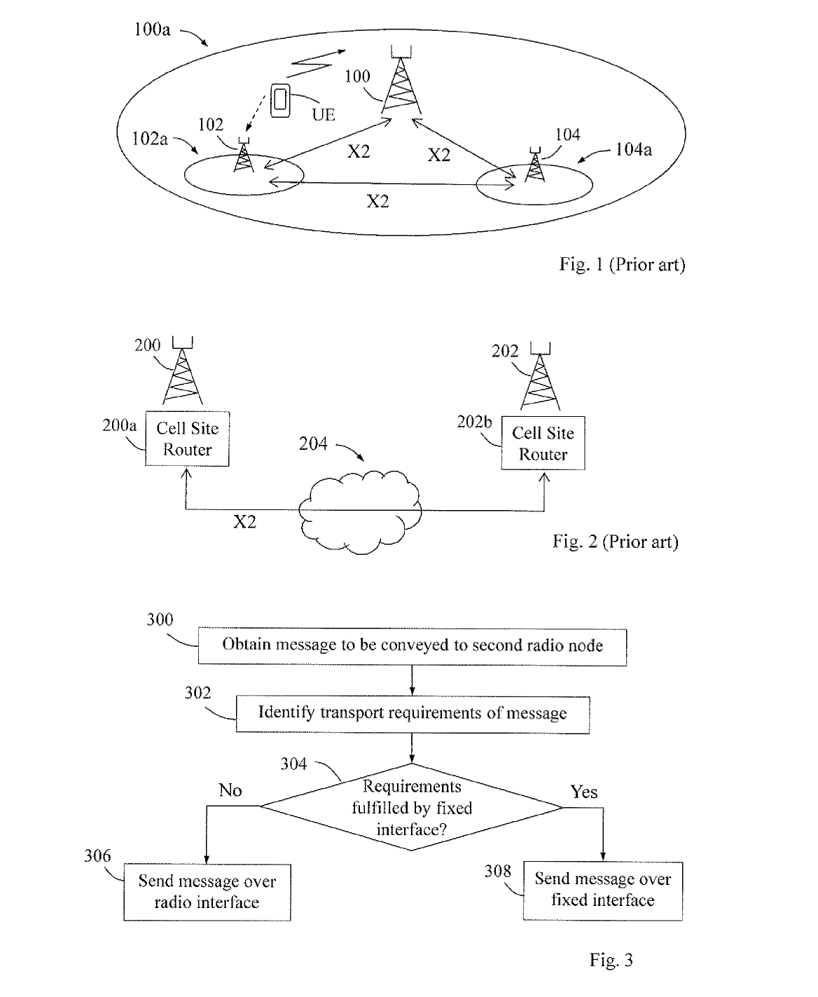

### DETAILED DESCRIPTION

Briefly described, a solution is provided to ensure that certain messages requiring rapid transfer from one radio node to another opposite radio node will reach the opposite radio node in time, even if an existing fixed interface between the radio nodes is not fast enough, e.g. due to temporary congestion and/or a substantial number of node hops. This can be achieved for a certain message to be transferred by checking if current link characteristics of the fixed interface can fulfill transport requirements of the message. If so, the message will be able to reach the opposite radio node in time when sent over the fixed interface, but if it is found that the current link characteristics of the fixed interface cannot fulfill the message's transport requirements, the message is sent over a radio interface instead. It can be assumed that a radio interface between two radio nodes is able to convey a message very rapidly since no intermediate node hops are involved.

It is thus an advantage of this solution that if a certain message is urgent and needs to be conveyed rapidly to the opposite radio node for processing, this can be ensured by sending the message over the radio interface which is generally a very fast interface. Another advantage is that other not so urgent messages will be conveyed over the fixed interface so as to not consume precious radio resources to no avail which can instead be used for radio communication with mobile terminals. Examples of urgent and time-critical messages include certain handover messages and cell coordination messages containing measurement data or the like that becomes out of date very quickly, or any messages containing real-time information that needs processing immediately at the receiving opposite radio node. Examples of non-urgent messages include messages related to network optimization, radio node configuration, neighbor lists, cell parameters, and so forth, which do not need immediate processing at the receiving side.

If the two radio nodes are not close enough to one other to enable a direct radio communication between the radio nodes, the message may be sent over an intermediate relaying radio node which relays the message from the sending radio node to the receiving radio node, provided that radio communication is possible between the sending radio node and the relaying radio node, and between the relaying radio node and the receiving radio node, respectively. Some possible embodiments, features and benefits of this solution will now be explained with reference to the drawings 3-7.

The solution outlined above and in the following examples may be realized by functionality in a first radio node of a mobile network for wireless communication. The term “radio node” is consistently used throughout this disclosure although other similar and fitting terms could be used as well. In practice, the first radio node described herein may be a base station, NodeB, e-NodeB, eNB, base transceiver station, etc., although the first radio node is not limited to these examples.

An example of how a first radio node of a mobile network for wireless communication may operate when employing the solution, will now be described with reference to the flow chart in FIG. 3 illustrating actions performed by the first radio node. The first radio node is operable to convey a message to a second radio node of the mobile network. The procedure illustrated by FIG. 3 may be repeated whenever any further messages are to be conveyed to the second radio node.

It is assumed that a fixed interface has been implemented between the first and second radio nodes, which can be used for conveying various messages at least in a direction from the first radio node to the second radio node. It is also assumed that different types of messages need to be conveyed from the first radio node to the second radio node more or less frequently, which messages may include, without limitation, cell coordination messages, reports of uplink and/or downlink signal measurements, messages related to handover, load management, network optimization, radio node configuration, neighbor lists, and parameters used for handover and cell reselection. These different types of messages have also different transport requirements, for example related to at least one of: latency, jitter and bandwidth.

A first action 300 illustrates that the first radio node obtains a message which is to be conveyed to the second radio node. The message may be generated at the first radio node or may alternatively be received from a third radio node of the mobile network such that the first radio node operates to relay the message to the second radio node, and this procedure is applicable for both scenarios.

In a next shown action 302, the first radio node identifies the transport requirements of this particular message, which may be done by determining a type, category or class of the message and checking a predefined look-up table or the like containing different transport requirements valid for different types of messages. In different possible embodiments, the identified transport requirements of the message may be related to at least one of: latency, jitter and bandwidth.

It may further be assumed that the first radio node is capable of recognizing which type of message the obtained message is. For example, the first radio node may identify the transport requirements of the message, e.g. from the above look-up table, by recognizing that the message is a cell coordination message. In a possible scenario of applying this procedure, a first coverage area provided by the first radio node may overlap at least partly with a second coverage area provided by the second radio node, and the cell coordination message may e.g. pertain at least to avoiding or reducing radio interference between transmissions in said coverage areas. The cell coordination message may also pertain to other things as well that may improve performance and/or capacity in the mobile network, e.g. in a CoMP scenario.

In a further action 304, the first radio node determines whether the identified transport requirements of the message can be fulfilled by link characteristics of the fixed interface to the second radio node. In a possible embodiment, the link characteristics of the fixed interface may be determined by obtaining measurements of one or more performance-related parameters including at least one of: latency, jitter and bandwidth of the fixed interface. The measurements may be made by the receiving radio node on one or more sent messages, which are reported to the sending radio node, i.e. the first radio node in this context: Such measurements may be done on any ongoing traffic of messages which may be used for cell coordination and other things, as exemplified above, and/or on dedicated measurement messages used for such measurements exclusively. Measurements of the above performance-related parameters may be obtained e.g. by requesting and receiving from the second radio node a time-stamp of reception of a sent message, or a bitrate or jitter as measured by the second radio node on one or more sent messages.

In another example, the measurements of the performance-related parameter(s) may thus be obtained when one or more dedicated measurement messages are sent from the first radio node over the fixed interface to the second radio node. The measurement message(s) may comprise a test message or the like used exclusively for measurement of performance-related parameters of the fixed interface and need not contain any intelligible information that needs processing at the receiving radio node, as long as it can be recognized as a measurement message. Some possible protocols that may be used for sending such measurement messages include IEEE 802.1ag, 802.3ah, ITU-T Y.1731 based or proprietary, although the solution is not limited to these exemplifying protocols. It is also possible to make corresponding measurements on messages sent over the radio interface to be compared with the measurements on the fixed interface, e.g. to make sure that the radio interface is faster before deciding to use it.

If it is found in action 304 that the transport requirements of the message cannot be fulfilled by the link characteristics of the fixed interface, the first radio node sends the message over a radio interface to the second radio node, in an action 306. It is thus assumed that the radio interface is able to provide the needed capacity and performance to fulfill the transport requirements of the message, e.g. in terms of latency or jitter or bandwidth or any combination thereof. On the other hand, if it is found in action 304 that the transport requirements of the message can be fulfilled by the link characteristics of the fixed interface, the first radio node sends the message over the fixed interface to the second radio node, in an action 308. The message is thus sent over the fixed interface whenever appropriate.

For example, when deciding to use the radio interface as of action 306 it may be discovered in action 304 that the latency of the fixed interface is too great such that the message would be delayed and cannot be conveyed rapidly enough, or that the jitter of the fixed interface, i.e. variations of delay, is too great such that timely arrival of the message cannot be ensured, or that the bandwidth of the fixed interface is too low such that the message cannot be conveyed with satisfactory bitrate. In another example, the transport requirements of the message may have been predefined as a “link condition” or the like for this type of message in terms of one or more thresholds pertaining to one or more of the above performance-related parameters, which link condition must be fulfilled by the fixed interface before it can be decided to safely send the message over the fixed interface to the second radio node. For example, the link condition may dictate that the latency of the fixed interface is below a latency threshold, or that the jitter of the fixed interface is below a jitter threshold, or that the bandwidth of the fixed interface is above a bandwidth threshold. Any combination of the above thresholds may further be dictated in the link condition.

The above-described actions may be performed by the first radio node in conjunction with further possible embodiments. It was mentioned above that the radio interface may be assumed to fulfill the transport requirements of the message, e.g. in terms of latency, jitter and/or bandwidth, which may possibly be confirmed by measurements on the radio interface as suggested above. Sometimes a situation may occur when neither of the fixed interface and the radio interface is good enough to fulfill the transport requirements of the message, which is however outside the scope of the embodiments herein. In that case, it would not be possible to convey this type of message such that its transport requirements are fulfilled, and the first radio node may be triggered to issue an alarm to a network management node or similar.

In a possible embodiment when the message is sent over the radio interface, radio resources may be scheduled for the message with higher priority than any radio signals communicated with mobile terminals over the radio interface. Thereby, it may be ensured basically that the latency, jitter and/or bandwidth of the radio interface will be “good” enough to fulfill the transport requirements of the message to be conveyed to the second radio node. In another possible embodiment of practical implementation, the mobile network may be an LTE network and the radio interface and the fixed interface may be used as an X2 interface.

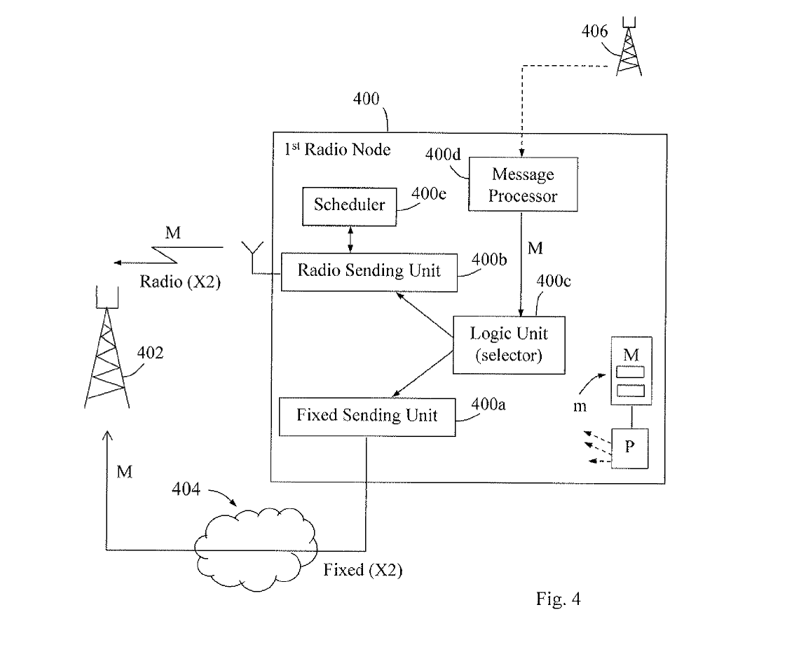

A detailed but non-limiting example of how a first radio node of a mobile network for radio communication may be structured with some possible functional units to bring about the above-described operation of the first radio node, is illustrated by the block diagram in FIG. 4. In this figure, the first radio node 400 is configured to convey a message “M” to a second radio node 402 of the mobile network. Again, it is assumed that a fixed interface is implemented which can be used for conveying various messages at least in a direction from the first radio node to the second radio node. The fixed interface runs over a transport network 404, which may also be called a backhaul network, and may involve a plurality of node hops over various switches and routers in the transport network 404. Furthermore, the route of node hops may vary from time to time in a more or less unpredictable fashion, e.g. if the transport network 404 involves the Internet. The first radio node 400 may be configured to operate according to any of the examples and embodiments described above and as follows. The first radio node 400 will now be described in terms of some possible examples of employing the solution.

The first radio node 400 comprises a fixed sending unit 400a configured to send messages over the fixed interface to the second radio node 402, and a radio sending unit 400b configured to send messages over a radio interface to the second radio node. The message M may be obtained from a message processor 400d or the like which may either generate the message locally in the first radio node 400 or receive the message M from a third radio node 406 of the mobile network, as indicated by a dashed arrow, to be forwarded to the second radio node 402 in a relaying fashion.

The first radio node 400 also comprises a logic unit 400c configured to identify transport requirements of the message M, e.g. in the manner described above for action 302. The logic unit 400c is further configured to decide that the first message should be sent to the second radio node over the radio interlace, shown by a full arrow, when the transport requirements of the message are not fulfilled by link characteristics of a fixed interface to the second radio node, or over the fixed interface, shown by a dashed arrow, when the transport requirements of the message are fulfilled by the link characteristics of the fixed interface. The logic unit 400c thus acts effectively as a “selector” by selecting between fixed transfer and radio transfer, and may be capable of operating according to any of the examples and embodiments described above for actions 302-308.

The above first radio node 400 and its functional units may be configured or adapted to operate according to various optional embodiments. In a possible embodiment, when the message is sent over the radio interface, the first radio node 400 may be configured to schedule radio resources for the message with higher priority than radio signals communicated with mobile terminals over the radio interface. In another possible embodiment, the logic unit 400c may be configured to determine the link characteristics of the fixed interface by obtaining measurements of at least one of: latency, jitter and bandwidth of the fixed interface.

In another possible embodiment, the first radio node may comprise a measurement unit, not shown in this figure, which is adapted to provide said measurements to the logic unit 400c when one or more measurement messages are sent from the first radio node over the fixed interface to the second radio node. Further, the logic unit 400c may be configured to identify the transport requirements of the message by recognizing that the message is a cell coordination message. In another possible embodiment, when the message M is received from a third radio node 406 of the mobile network, the first radio node may be configured to relay the message to the second radio node 402.

It should be noted that FIG. 4 illustrates some possible functional units in the first radio node 400 and the skilled person is able to implement these functional units in practice using suitable software and hardware. Thus, the solution is generally not limited to the shown structures of the first radio node 400, and the functional units 400a-d may be configured to operate according to any of the features described in this disclosure, where appropriate.

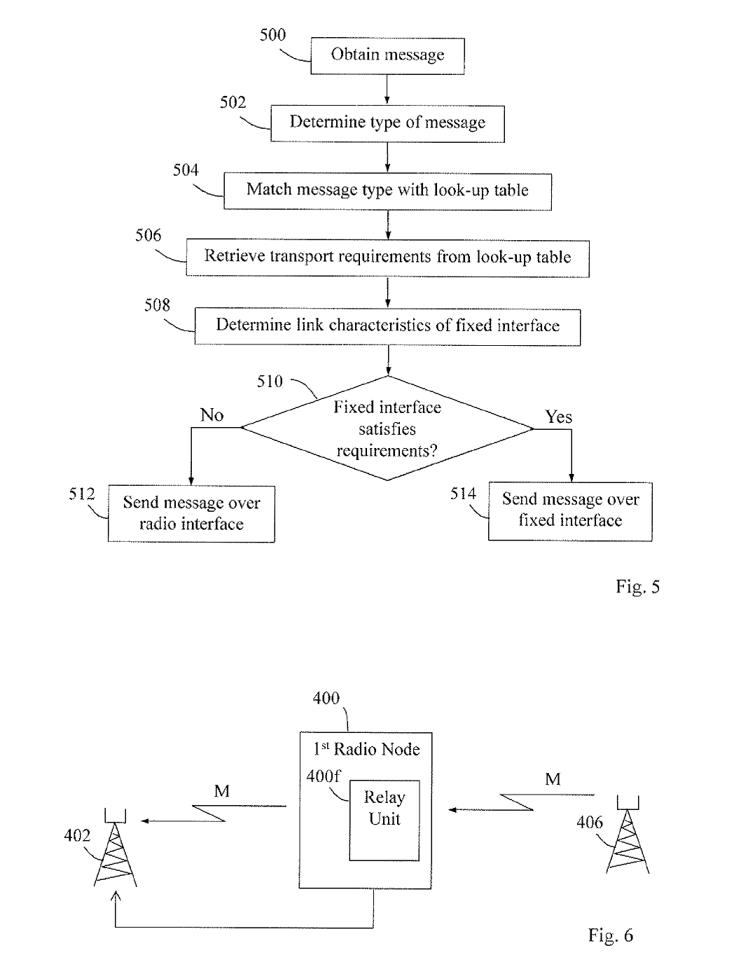

The embodiments and features described herein may be implemented in a computer program comprising computer readable code which, when run on a first radio node, causes the first radio node to perform the above actions e.g. as described for FIGS. 3 and 5 and the appropriate functionality described for the first radio node 400 in FIGS. 4, 6 and 7. Further, the above-described embodiments may be implemented in a computer program product comprising a computer readable medium on which a computer program is stored. The computer program product may be a compact disc or other carrier suitable for holding the computer program. The computer program comprises computer readable code which, when run on a first radio node, causes the first radio node to perform the above actions. Some examples of how the computer program and computer program product can be realized in practice are outlined below.

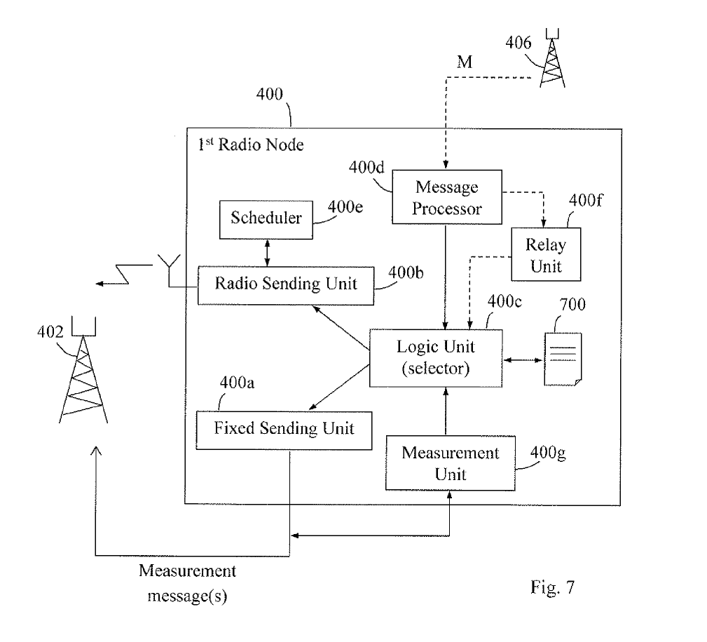

The functional units 400a-d described above for FIGS. 4 and 7 may be implemented in the first radio node 400 by means of program modules of a respective computer program comprising code means which, when run by a processor “P” causes the first radio node 400 to perform the above-described actions and procedures. The processor P may comprise a single Central Processing Unit (CPU), or could comprise two or more processing units. For example, the processor P may include a general purpose microprocessor, an instruction set processor and/or related chips sets and/or a special purpose microprocessor such as an Application Specific Integrated Circuit (ASIC). The processor P may also comprise a storage for caching purposes.

Each computer program may be carried by a computer program product in the first radio node 400 in the form of a memory “M” having a computer readable medium and being connected to the processor P. The computer program product or memory M thus comprises a computer readable medium on which the computer program is stored e.g. in the form of computer program modules “m”. For example, the memory M may be a flash memory, a Random-Access Memory (RAM), a Read-Only Memory (ROM) or an Electrically Erasable Programmable ROM (EEPROM), and the program modules m could in alternative embodiments be distributed on different computer program products in the form of memories within the first radio node 400.

A more detailed example of how the above-described first radio node may operate will now be briefly outlined with reference to the flow chart of FIG. 5. In this example it is assumed that the first radio node is able to access a look-up table containing different transport requirements valid for different types of messages. The look-up table may be implemented in the first radio node or other suitable location allowing quick access. The transport requirements of at least some of the message types may have been predefined in terms of a link condition or the like in the manner described above. A first action 500 illustrates that the first radio node obtains a message to be conveyed to a second radio node, e.g. from a message processor that has either generated the message locally at the first radio node or received the message from a third radio node. This action basically corresponds to action 300 above.

In a following action 502, the first radio node determines, or recognizes, a type of the obtained message which may be any of a cell coordination message, a report of uplink and/or downlink signal measurements, a message related to handover, load management, network optimization, radio node configuration, neighbor lists, and a message with parameters used for handover and cell reselection, although the solution is not limited to these examples of message types. Different types of messages may have different transport requirements, for example related to latency, jitter and/or bandwidth, as discussed above.

The first radio node then matches the recognized message type with entries in the look-up table, in a further action 504, and when a match is found, the first radio node retrieves transport requirements of the message from the matching entry in the look-up table, in an action 506. A next action 508 illustrates that the first radio node determines link characteristics of the fixed interface, which may be done by obtaining measurements on the fixed interface in the manner described above for action 304. It should be noted that action 508 may be performed on a more or less continuous basis, e.g. regardless of whether there is a pending message to convey or not, so that this information is always up-to-date and available in the first radio node. Action 508 may thus be executed at any time independent of the other actions in the figure and not necessarily after action 506.

Further, the first radio node may maintain link characteristics of fixed interfaces to other radio nodes it may communicate with, e.g. in a table or the like. This table may further contain current link characteristics of corresponding radio interfaces to the radio nodes as well which may be used for comparison.

Depending on the implementation, the link characteristics of the fixed interface between the first and second radio nodes may vary over time in a more or less unpredictable manner, e.g. due to varying conditions such as varying load on nodes and links in the transport network and selection of node hops. In another scenario, the link characteristics of the fixed interface may be more or less stable and predictable, e.g. if the fixed interface runs over a succession of known nodes and links having unchanging characteristics every time a message is conveyed. In that case, repeated measurements on the fixed interface may not be necessary to establish its link characteristics. The involved nodes and links may e.g. be owned and controlled by the network operator.

The first radio node then determines whether the fixed interface is able to satisfy the transport requirements of the message or not, in another action 510, which corresponds basically to the above action 304. If it is found that the transport requirements of the message cannot be satisfied by the fixed interface, the first radio node sends the message over the radio interface to the second radio node, in an action 512. If satisfied by the fixed interface, the first radio node sends the message over the fixed interface to the second radio node, in an action 514. Actions 512 and 514 basically correspond to the above actions 306 and 308, respectively.

It was mentioned above that the first radio node may relay the message to the second radio node in the case when the message is received from a third radio node. This scenario is schematically illustrated in FIG. 6 where the first radio node 400 of FIG. 4 further comprises a relay unit 4001 which is used for relaying the message M received from the third radio node 406 to the second radio node 402. The procedures shown in FIGS. 3 and 5, respectively, which include deciding whether to send the message over the fixed interface or over the radio interface, may be applied in the manner described above also in the case of such a relayed message. A relayed message may basically be routed over any number of radio nodes using any combination of fixed and radio interfaces, by employing the mechanism provided by the embodiments herein.

A detailed example of how the above-described first radio node 400 may be implemented in practice will now be briefly outlined with reference to the block diagram of FIG. 7. This figure illustrates that the first radio node 400 comprises a fixed sending unit 400a, a radio sending unit 400b, a logic unit 400c, and a message processor 400d, as in FIG. 4. These functional units have all been described above already which will not be repeated here. The first radio node 400 further comprises a scheduler function 400e which, when the message is sent over the radio interface, is configured to schedule radio resources for the message with higher priority than radio signals communicated with mobile terminals over the radio interface, if needed depending on the current traffic load, to ensure that the message is sent with sufficient urgency.

The first radio node 400 further comprises a relay unit 400f configured to relay the message M to the second radio node 402 in the case when the message M is received from the third radio node 406. The received message M is processed by the shown message processor 400d which may be configured to recognize that the message M is directed to the second radio node and not to the first radio node, and in that case just forwards the message to the relay unit 400f which ensures that the message is relayed accordingly.

The first radio node 400 also comprises a measurement unit 400g configured to measure at least one of: latency, jitter and bandwidth of the fixed interface, so that these measurements can be used by the logic unit 400c to determine link characteristics of the fixed interface, e.g. as described for actions 304 and 508 above. As indicated in the figure, the measurements may be performed on one or more dedicated measurement messages exclusively used for measuring purposes. The measurement unit 400g is thus adapted to provide said measurements to the logic unit 400c when one or more measurement messages are sent from the first radio node over the fixed interface to the second radio node.

The first radio node 400 also comprises a look-up table 700 containing different transport requirements valid for different types of messages. The logic unit 400c may thus retrieve information from the look-up table 700 to determine the transport requirements of the message M to be conveyed to the second radio node, in the manner described above.

While the solution has been described with reference to specific exemplary embodiments, the description is generally only intended to illustrate the inventive concept and should not be taken as limiting the scope of the solution. For example, the terms “radio node”, “message”, “transport requirements”, “link characteristics”, “radio sending unit”, “fixed sending unit”, “logic unit”, and “measurement message” have been used throughout this description, although any other corresponding entities, functions, and/or parameters could also be used having the features and characteristics described here. The solution is defined by the appended claims.

1-20. (canceled)

21. A method performed by a first radio node of a mobile network for wireless communication, for conveying a message to a second radio node of the mobile network, the method comprising:
identifying transport requirements of the message, and
sending the message over a radio interface to the second radio node when the transport requirements of the message are not fulfilled by link characteristics of a fixed interface to the second radio node, or sending the message over the fixed interface to the second radio node when the transport requirements of the message are fulfilled by the link characteristics of the fixed interface.

22. The method of claim 21, wherein when the message is sent over the radio interface, radio resources are scheduled for the message with higher priority than radio signals communicated with mobile terminals over the radio interface.

23. The method of claim 21, wherein the identified transport requirements of the message are related to at least one of: latency, jitter and bandwidth.

24. The method of claim 21, wherein the link characteristics of the fixed interface are determined by obtaining measurements of at least one of: latency, jitter and bandwidth of the fixed interface.

25. The method of claim 24, wherein said measurements are obtained when one or more measurement messages are sent from the first radio node over the fixed interface to the second radio node.

26. The method of claim 21, wherein the transport requirements of the message are identified by recognizing that the message is a cell coordination message.

27. The method of claim 26, wherein a first coverage area provided by the first radio node overlaps at least partly with a second coverage area provided by the second radio node, and the cell coordination message pertains at least to avoiding or reducing radio interference between transmissions in said coverage areas.

28. The method of claim 21, wherein the message is first received from a third radio node of the mobile network, and the first radio node relays the message to the second radio node.

29. The method of claim 21, wherein the mobile network is a Long Term Evolution (LTE) network and the radio interface or the fixed interface is used as an X2 interface.

30. A first radio node of a mobile network for wireless communication, the first radio node being configured to convey a first message to a second radio node of the mobile network, the first radio node comprising processing circuitry configured to:
send messages over a fixed interface to the second radio node,
a send messages over a radio interface to the second radio node, and
identify transport requirements of the first message and to decide that the first message should be sent to the second radio node over the radio interface when the transport requirements of the first message are not fulfilled by link characteristics of a fixed interface to the second radio node or over the fixed interface when the transport requirements of the first message are fulfilled by the link characteristics of the fixed interface.

31. The first radio node of claim 30, wherein the processing circuit is configured such that when the first message is sent over the radio interface, the processing circuit schedules radio resources for the first message with higher priority than radio signals communicated to mobile terminals over the radio interface.

32. The first radio node of claim 30, wherein the identified transport requirements of the first message are related to at least one of: latency, jitter and bandwidth.

33. The first radio node of claim 30, wherein the processing circuit is configured to determine the link characteristics of the fixed interface by obtaining measurements of at least one of: latency, jitter and bandwidth of the fixed interface.

34. The first radio node of claim 33, wherein said measurements are obtained by the processing circuit for determining the link characteristics of the fixed interface when one or more measurement messages are sent from the first radio node over the fixed interface to the second radio node.

35. The first radio node of claim 30, wherein the processing circuit is configured to identify the transport requirements of the first message by recognizing that the first message is a cell coordination message.

36. The first radio node of claim 35, wherein a first coverage area provided by the first radio node overlaps at least partly with a second coverage area provided by the second radio node, and the cell coordination message pertains at least to avoiding or reducing radio interference between transmissions in said coverage areas.

37. The first radio node of claim 30, wherein when the first message is received from a third radio node of the mobile network, the processing circuit is configured to relay the first message to the second radio node.

38. The first radio node of claim 30, wherein the mobile network is a Long Term Evolution (LTE) network and the radio interface or the fixed interface is used as an X2 interface.

39. A non-transitory computer-readable medium comprising, stored thereupon, a computer program comprising computer readable code that, when run on a first radio node of a mobile communications network, causes the first radio node to convey a message to a second radio node of the mobile network by:
identifying transport requirements of the message, and
sending the message over a radio interface to the second radio node when the transport requirements of the message are not fulfilled by link characteristics of a fixed interface to the second radio node, or sending the message over the fixed interface to the second radio node when the transport requirements of the message are fulfilled by the link characteristics of the fixed interface.
